(19) United States
(12) Patent Application Publication
(10) Pub. No.: US 2026/0247458 A1
(43) Pub. Date: Aug. 20, 2026

(54) COMMUNICATION METHOD AND COMMUNICATION DEVICE FOR TUNNELED DIRECT LINK SETUP

(71) Applicant: BEIJING XIAOMI MOBILE SOFTWARE CO., LTD., Beijing (CN)

(72) Inventor: Yajun CHENG, Beijing (CN)

(73) Assignee: BEIJING XIAOMI MOBILE SOFTWARE CO., LTD., Beijing (CN)

(21) Appl. No.: 19/164,570

(22) PCT Filed: Mar. 15, 2023
(86) PCT No.: PCT/CN2023/081756

§ 371 Date: Sep. 11, 2025

(51) Int. Cl. H04W 76/14; H04W 76/12

(52) U.S. Cl. CPC H04W 76/14; H04W 76/12

(57) ABSTRACT

A communication method for tunneled direct link setup (TDLS) includes sending a TDLS discovery request frame including one or more basic service set identifiers (BSSIDs), where each BSSID indicates an identifier of a BSS to which a station device with which the TDLS initiator intends to set up a TDLS connection belongs; receiving a TDLS discovery response frame to discover a station device with a TDLS function; sending a TDLS setup request frame, where the TDLS setup request frame includes one or more BSSIDs, each BSSID in the TDLS setup request frame indicates an identifier of a BSS to which a station device discovered by the TDLS initiator belongs; and receiving a TDLS setup response frame, where the TDLS setup response frame includes one or more status identifiers, and each status identifier indicates a status of a TDLS connection setup request corresponding to a respective BSSID.

### CROSS-REFERENCE TO RELATED APPLICATION

The present application is a U.S. National Stage of International Application No. PCT/CN2023/081756, filed on Mar. 15, 2023, the entire content of which is incorporated herein by reference for all purposes.

### TECHNICAL FIELD

The present disclosure relates to the field of wireless communications, and more specifically, to a communication method and a communication device for tunneled direct link setup (TDLS).

### BACKGROUND

To achieve higher throughput, lower network latency, and greater reliability, multi-link operation (MLO) technology has been introduced in Wi-Fi technology. A device supporting an MLO function is called a multi-link device (MLD). The MLD may include an access point multi-link device (AP MLD) and a non-AP MLD. Through the MLO technology, a plurality of links may be set up across frequency bands between the non-AP MLD and the AP MLD.

### SUMMARY

According to a first aspect of the present disclosure, a communication method for TDLS is provided. The communication method is applied to a TDLS initiator and includes: sending a TDLS discovery request frame, where the TDLS discovery request frame includes one or more basic service set identifiers (BSSIDs), and each BSSID indicates an identifier of a basic service set (BSS) to which a station device with which the TDLS initiator intends to set up a TDLS connection belongs; receiving a TDLS discovery response frame to discover a station device with a TDLS function; sending a TDLS setup request frame, where the TDLS setup request frame includes one or more BSSIDs, and each BSSID indicates an identifier of a BSS to which a station device discovered by the TDLS initiator and with which the TDLS initiator intends to set up the TDLS connection belongs; and receiving a TDLS setup response frame, where the TDLS setup response frame includes one or more status identifiers, and each status identifier indicates a status of a TDLS connection setup request corresponding to a respective BSSID.

According to a second aspect of the present disclosure, a communication method for TDLS is provided. The communication method is applied to a TDLS responder and includes: receiving a TDLS discovery request frame, where the TDLS discovery request frame includes one or more BSSIDs, and each BSSID indicates an identifier of a BSS to which a station device with which a TDLS initiator intends to set up a TDLS connection belongs; sending a TDLS discovery response frame when a BSSID in the TDLS discovery request frame corresponds to a BSSID to which the TDLS responder belongs; receiving a TDLS setup request frame, where the TDLS setup request frame includes one or more BSSIDs, and each BSSID indicates an identifier of a BSS to which a station device discovered by the TDLS initiator and with which the TDLS initiator intends to set up the TDLS connection belongs; and sending a TDLS setup response frame when a BSSID in the TDLS setup request frame corresponds to the BSSID to which the TDLS responder belongs, where the TDLS setup response frame includes one or more status identifiers, and each status identifier indicates a status of a TDLS connection setup request corresponding to a respective BSSID.

According to a third aspect of the present disclosure, an electronic device is provided. The electronic device includes a memory, a processor, and a computer program stored in the memory and capable of being run on the processor, where the processor, when executing the computer program, implements the method described above.

Additional aspects and advantages of the embodiments of the present disclosure will be partially provided in the following description, which will become apparent from the following description or will be learned through practice of the present disclosure.

### BRIEF DESCRIPTION OF THE DRAWINGS

The above and other features of the embodiments of the present disclosure will become clearer by referring to the accompanying drawings to describe in detail the embodiments of the present disclosure.

FIG. 1 is a flowchart illustrating a TDLS discovery process according to an embodiment.

FIG. 2 is a flowchart illustrating a TDLS discovery process according to an embodiment.

FIGS. 3 and 4 are interaction flowcharts illustrating a TDLS discovery process according to an embodiment.

FIG. 5 is a flowchart illustrating a TDLS setup process according to an embodiment.

FIG. 6 is a flowchart illustrating a TDLS setup process according to an embodiment.

FIG. 7 is an interaction flowchart illustrating a TDLS setup process according to an embodiment.

FIG. 8 illustrates a communication method for TDLS according to an embodiment of the present disclosure.

FIGS. 9 and 10 illustrate interaction flowcharts for TDLS according to an embodiment of the present disclosure.

FIG. 11 illustrates a communication method for TDLS according to an embodiment of the present disclosure.

FIG. 12 is a block diagram illustrating a communication device according to an embodiment of the present disclosure.

### DETAILED DESCRIPTION

The following description with reference to the accompanying drawings is provided to assist in a comprehensive understanding of various embodiments of the present disclosure as defined by the appended claims and their equivalents. Various embodiments of the present disclosure include various specific details, but these specific details are considered merely exemplary. Furthermore, for clarity and brevity, descriptions of well-known techniques, functions, and structures may be omitted.

The terms and expressions used in the present disclosure are not limited to their written meanings, but are used solely by the inventor to enable a clear and consistent understanding of the present disclosure. Therefore, for those skilled in the art, the description of various embodiments of the present disclosure is provided for illustrative purposes only and not for limiting purposes.

It should be understood that unless the context otherwise clearly indicates, the singular forms “a,” “one,” “the,” and “said” as used herein may also include the plural forms. It should be further understood that the term “including” as used in the present disclosure refers to the presence of the described features, integers, steps, operations, elements, and/or components, but does not exclude the presence or addition of one or more other features, integers, steps, operations, elements, components, and/or groups thereof.

It will be understood that although the terms “first”, “second”, etc., may be used in this article to describe various elements, these elements should not be limited by these terms. These terms are used merely to distinguish one element from another. Therefore, without departing from the teachings of the embodiments, the first element discussed below may be referred to as the second element.

It should be understood that when an element is referred to as being “connected” or “coupled” to another element, it may be directly connected or coupled to another element, or intermediate elements may also exist. Furthermore, the terms “connected” or “coupled” as used herein may include a wireless connection or a wireless coupling. The term “and/or” or the expression “at least one of . . . ” used herein includes any and all combinations of one or more of the associated listed items.

Unless otherwise defined, all terms used herein (including technical and scientific terms) have the same meaning as generally understood by those ordinary skilled in the art to which the present disclosure relates.

A peer to peer (P2P) communication mode enables data transmission without requiring an access point, avoiding latency caused by network congestion, and further enhancing transmission efficiency. In current wireless communication technology, the non-AP MLD supports the P2P communication, i.e., a TDLS function. However, the related art lacks a TDLS discovery and setup mechanism applicable to the MLD.

In a wireless local area network, a BSS may consist of an access point (AP) and one or more non-APs (referred to herein as stations (STAs) or station devices) communicating with the AP. A BSS may be connected to a distribution system (DS) via its AP, then access another BSS to form an extended service set (ESS).

The AP is a wireless switch for a wireless network, and is also an access device for the wireless network. The AP device may be used as a wireless base station, mainly as a bridge to connect the wireless network and a wired network. Utilizing such an AP enables integration of the wired network and the wireless network.

The AP may include a software application and/or a circuit to enable other types of nodes in the wireless network to communicate with the outside and inside of the wireless network via the AP. In some examples, the AP may be a terminal device or a network device equipped with a wireless fidelity (Wi-Fi) chip.

As an example, the station (STA) may include, but is not limited to, a cellular phone, a smartphone, a wearable device, a computer, a personal digital assistant (PDA), a personal communication system (PCS) device, a personal information manager (PIM), a personal navigation device (PND), a global positioning system (GPS), a multimedia device, an Internet of Things (IoT) device, etc.

In an embodiment of the present disclosure, the AP and the STA may support a multi-link device, which may, for example, be represented as an AP MLD and a non-AP MLD respectively.

In a certain BSS, the non-AP MLD may discover a station device (STA) supporting a TDLS function through a TDLS discovery request/response frame. For example, the discovered STA may include an STA affiliated with another non-AP MLD or a non-multi-link device STA. Subsequently, a TDLS connection is negotiated and set up through a TDLS setup request/response frame. After a TDLS connection is successfully set up, the non-AP MLD may directly perform data transmission with a corresponding TDLS station device through the TDLS connection as set up.

In an embodiment of the present disclosure, affiliated stations of the non-AP MLD operating under different connections may be in different BSSs.

For example, in a TDLS station device discovery phase, when a TDLS initiator is a non-AP MLD, a plurality of TDLS discovery request frames may be repeatedly sent to discover the presence of a TDLS station device. Sending the plurality of TDLS discovery request frames incurs significant signaling overhead. Furthermore, the related art only supports single-link TDLS between multi-link devices. To implement multi-link TDLS, TDLS discovery and setup processes need to be performed under each link, which not only incurs signaling overhead but also leads to excessively long TDLS connection setup time, affecting transmission efficiency.

In view of the above, according to the embodiments of the present disclosure, there is provided a communication method and a communication device for TDLS.

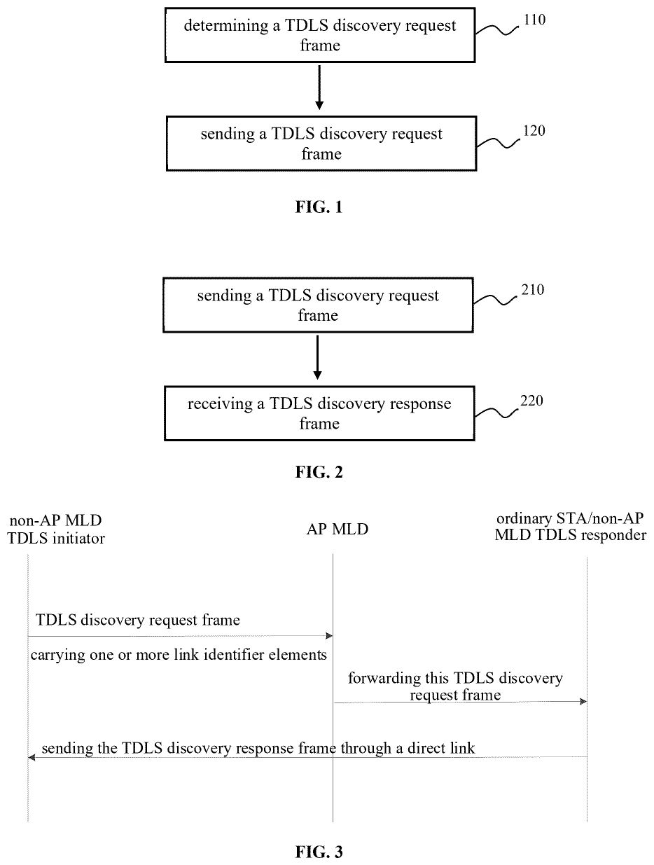

FIG. 1 is a flowchart illustrating a TDLS discovery process according to an embodiment. The communication method shown in FIG. 1 may be applied to a TDLS initiator. For example, the TDLS initiator may be a non-AP MLD.

Referring to FIG. 1, in operation 110, the TDLS initiator may determine a TDLS discovery request frame; and in operation 120, the TDLS initiator may send the TDLS discovery request frame. In an embodiment of the present disclosure, there may be many ways to determine the TDLS discovery request frame. For example, the TDLS initiator (non-AP MLD) may generate the TDLS discovery request frame based on at least one of the following: a network condition, a load condition, a hardware capability of a sending/receiving device, a service type, and a relevant protocol specification, which is not specifically limited in the embodiments of the present disclosure. In an embodiment of the present disclosure, the TDLS initiator (non-AP MLD) may also obtain the TDLS discovery request frame from an external device, and the embodiments of the present disclosure do not make specific limitations on this.

According to an embodiment of the present disclosure, the TDLS discovery request frame may include one or more BSSIDs, where each BSSID indicates an identifier of a BSS to which a station device with which the TDLS initiator intends to set up a TDLS connection belongs. If the TDLS initiator intends to set up a TDLS connection with a non-MLD station (hereinafter also referred to as an ordinary STA), or intends to set up a TDLS connection with an affiliated STA of a non-AP MLD, the TDLS discovery request frame may include a BSSID. If the TDLS initiator intends to set up a TDLS connection with a plurality of non-MLD stations or a plurality of affiliated STAs affiliated with one or more non-AP MLDs, the TDLS discovery request frame may include a plurality of BSSIDs.

According to an embodiment of the present disclosure, one or more TDLS BSSIDs may be carried in the TDLS discovery request frame in the form of link identifier elements.

In an embodiment of the present disclosure, the TDLS discovery request frame may include a plurality of BSSIDs, and the plurality of BSSIDs may be carried (included) in a link identifier element. As shown in Table 1 below, information of a TDLS discovery request frame action field is provided.

TABLE 1
(TDLS Discovery Request frame Action field)

| Order | Information |
|---|---|
| 1 | Category |
| 2 | TDLS Action |
| 3 | Dialog Token |
| 4 | Link Identifier |
| 5 | Multi-Link |

It should be understood that the information in the TDLS discovery request frame shown in Table 1, as well as the order of the information, is not limited to this. The contents in Table 1 may be varied according to different embodiments.

When the TDLS discovery request frame includes a plurality of BSSIDs, the plurality of BSSIDs may be included, in a form of a list, in a link identifier element of the TDLS discovery request frame. As shown in Table 2 below, an example of the link identifier element is provided.

TABLE 2
Link Identifier Element

| | | | TDLS | TDLS | |
|---|---|---|---|---|---|
| | Element | | initiator | responder | BSSID |
| | ID | Length | STA Address | STA Address | List |
| Octets: | 1 | 2 | 6 | 6 | variable |

Referring to Table 2, the link identifier element may include an element identifier (Element ID) that identifies the link identifier element, a length field (Length) that indicates the length information of the link identifier element, and a BSSID list (BSSID List). Each BSSID in the BSSID list may indicate an identifier of a BSS to which a station device with which the TDLS initiator intends to set up a TDLS connection belongs, such as BSSID 1, BSSID 2, etc. in the BSSID list shown in Table 3 below.

TABLE 3
BSSID List

| | BSSID 1 | BSSID 2 | . . . |
|---|---|---|---|
| Octets: | 6 | 6 | |

In an embodiment of the present disclosure, a plurality of BSSIDs may indicate the identifiers of BSSs to which a plurality of affiliated STAs (e.g., with which the TDLS initiator intends to set up a TDLS connection) serving as TDLS responders of the non-AP MLD.

Furthermore, according to an embodiment of the present disclosure, the link identifier element may also include a TDLS initiator STA address (e.g., the MAC address of the TDLS initiator non-AP MLD) and a TDLS responder STA address (e.g., the MAC address of a non-multi-link device (ordinary STA) that may serve as a TDLS responder, or the MAC address of a non-AP MLD whose affiliated STA may serve as a TDLS responder).

It should be understood that the contents shown in Table 2 are merely exemplary, and are not limitations to the present disclosure. Furthermore, although the contents shown in Table 2 are exemplarily listed in the same table, this does not imply that all contents in Table 2 must coexist simultaneously; and variations may be made according to embodiments.

Additionally, although Tables 2 and 3 show the size (number of bits) of each subfield, this is merely exemplary and not limitations to the present disclosure.

In another embodiment of the present disclosure, the TDLS discovery request frame may include a plurality of BSSIDs, and the plurality of BSSIDs may be carried (included) in a plurality of link identifier elements respectively. As shown in Table 4 below, information of a TDLS discovery request frame action field is provided.

TABLE 4
TDLS Discovery Request frame Action field

| Order | Information |
|---|---|
| 1 | Category |
| 2 | TDLS Action |
| 3 | Dialog Token |
| 4 | A plurality of Link Identifiers |
| 5 | Multi-Link |

It should be understood that the information in the TDLS discovery request frame shown in Table 4, as well as the order of the information, is not limited to this. The contents in Table 4 may be varied according to different embodiments.

When the TDLS discovery request frame includes a plurality of BSSIDs, the plurality of BSSIDs may be included in a plurality of link identifier elements in the TDLS discovery request frame respectively. Each link identifier element carries a different BSSID. The format of each link identifier element may be as shown in Table 5 below.

TABLE 5
Link Identifier Element

| | Element | | | TDLS initiator | TDLS responder |
|---|---|---|---|---|---|
| | ID | Length | BSSID | STA Address | STA Address |
| Octets: | 1 | 2 | 6 | 6 | 6 |

The element identifiers and lengths in Table 5 are similar to those in the aforementioned Table 2. For brevity, redundant descriptions are omitted. According to an embodiment of the present disclosure, each link identifier element may include a BSSID to which a station requested by the TDLS initiator for a TDLS connection belongs. Furthermore, according to an embodiment of the present disclosure, each link identifier element may further include a TDLS initiator STA address (e.g., the MAC address of the TDLS initiator non-AP MLD) and a TDLS responder STA address (e.g., the MAC address of a non-multi-link device (ordinary STA) that may serve as a TDLS responder and correspond to the BSSID, or the MAC address of a non-AP MLD whose affiliated STA may serve as a TDLS responder and that corresponds to the BSSID).

It should be understood that the contents shown in Table 5 are merely exemplary, and are not limitations to the present disclosure. Furthermore, although the contents shown in Table 5 are exemplarily listed in the same table, this does not imply that all contents in Table 5 must coexist simultaneously; and variations may be made according to embodiments.

Additionally, although Table 5 shows the size (number of bits) of each subfield, this is merely exemplary and not limitations to the present disclosure.

FIG. 2 is a flowchart illustrating a TDLS discovery process according to an embodiment. The communication method shown in FIG. 2 may be applied to a TDLS initiator, for example, the TDLS initiator may be a non-AP MLD.

Referring to FIG. 2, in operation 210, the TDLS initiator may send a TDLS discovery request frame. In some embodiments, the TDLS discovery request frame may include one or more BSSIDs, where each BSSID indicates an identifier of a BSS to which a station device with which the TDLS initiator intends to set up a TDLS connection belongs.

According to an embodiment of the present disclosure, when the TDLS discovery request frame includes a plurality of BSSIDs, the TDLS discovery request frame may include one or more link identifier elements. As shown in Table 6 below, information of a TDLS discovery request frame action field is provided.

TABLE 6
TDLS Discovery Request frame Action field

| Order | Information |
|---|---|
| 1 | Category |
| 2 | TDLS Action |
| 3 | Dialog Token |
| 4 | One or more Link Identifiers |
| 5 | Multi-Link |

It should be understood that the information in the TDLS discovery request frame shown in Table 6, as well as the order of the information, is not limited to this. The contents in Table 6 may be varied according to different embodiments.

In an embodiment of the present disclosure, the TDLS discovery request frame may include a link identifier element, and the plurality of BSSIDs in the TDLS discovery request frame may be included in the link identifier element in a form of a list (this may be analogous to the embodiments described in Tables 2 and 3 above; for brevity, redundant descriptions are omitted herein). Alternatively, the TDLS discovery request frame may include a plurality of link identifier elements, where each BSSID of the plurality of BSSIDs in the TDLS discovery request frame is included in a respective link identifier element (this may be analogous to the embodiments described in Table 5 above; for brevity, redundant descriptions are omitted herein).

In operation 220, the TDLS initiator may receive a TDLS discovery response frame to discover (or determine) a station device with a TDLS function. The TDLS initiator may determine the station device with the TDLS function based on the received TDLS discovery response frame.

According to the communication method of the embodiments of the present disclosure, when the TDLS initiator is a non-AP MLD, one or more BSSIDs may be carried in one TDLS discovery request frame. This eliminates the need to repeatedly send a plurality of TDLS discovery request frames to discover the TDLS station device, thereby reducing signaling overhead.

FIG. 3 is an interaction flowchart illustrating a TDLS discovery process according to an embodiment.

Referring to FIG. 3, the TDLS initiator (non-AP MLD) may send a TDLS discovery request frame to an AP MLD, where the AP MLD is associated with the TDLS initiator and has set up a multilink with the TDLS initiator. As described above with reference to FIGS. 1 and 2 and Tables 1 to 6, the TDLS discovery request frame may include one or more link identifier elements. For example, the TDLS discovery request frame may carry a plurality of link identifier elements, and each link identifier element carries a different BSSID; or the TDLS discovery request frame may carry a link identifier element including a plurality of BSSIDs.

Continuing with reference to FIG. 3, upon receiving the TDLS discovery request frame sent by the TDLS initiator (non-AP MLD), the AP MLD may forward this TDLS discovery request frame to a corresponding station device. For example, the AP MLD may forward the TDLS discovery request frame to the station device (TDLS responder) identified by the destination address (DA) in the TDLS discovery request frame. In other words, the TDLS discovery request frame sent by the TDLS initiator is forwarded to the corresponding station device via the multi-link access point device.

Upon receiving the TDLS discovery request frame sent by the AP MLD associated with the TDLS responder, the TDLS responder may determine whether to reply with a TDLS discovery response frame based on the received TDLS discovery request frame.

In an embodiment of the present disclosure, the TDLS responder may be a non-multi-link station device. If at least one BSSID included in the TDLS discovery request frame received by the TDLS responder is a BSS to which the TDLS responder itself belongs, the TDLS responder may send the TDLS discovery response frame to the TDLS initiator through a direct link; otherwise, the TDLS responder does not send the TDLS discovery response frame. On the other hand, although at least one BSSID included in the TDLS discovery request frame received by the TDLS responder is the BSS to which the TDLS responder itself belongs, if the TDLS responder itself does not support the TDLS function, the TDLS responder does not send the TDLS discovery response frame.

In another embodiment of the present disclosure, the TDLS responder may be a non-AP MLD. If at least one BSSID included in the TDLS discovery request frame received by the TDLS responder is a BSS to which an affiliated STA of the TDLS responder belongs, the affiliated STA of the TDLS responder corresponding to that BSSID may send the TDLS discovery response frame to the TDLS initiator through a direct link; otherwise, the TDLS responder does not send the TDLS discovery response frame. On the other hand, although at least one BSSID included in the TDLS discovery request frame received by the TDLS responder is a BSS to which an affiliated STA of the TDLS responder belongs, if the TDLS responder itself does not support the TDLS function, the TDLS responder does not send the TDLS discovery response frame.

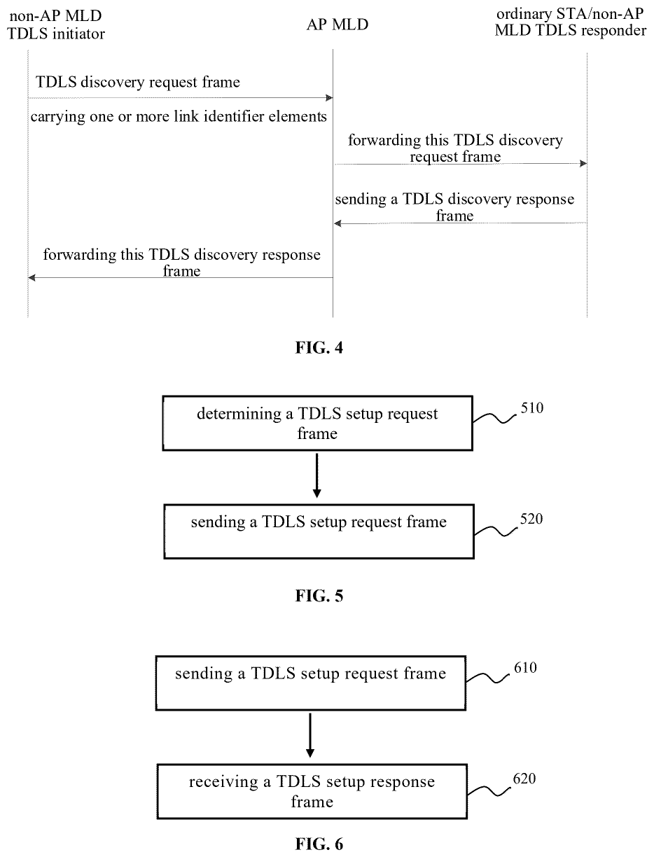

FIG. 4 is an interaction flowchart illustrating a TDLS discovery process according to an embodiment. In FIG. 4, except that the TDLS discovery response frame is forwarded to the TDLS initiator via a multi-link access point device, the other processes are the same as those in FIG. 3. For brevity, redundant descriptions are omitted herein.

Furthermore, although FIGS. 3 and 4 show that the TDLS initiator receives the TDLS discovery response frame from only one TDLS responder, the present disclosure is not limited to this. The TDLS initiator may receive one or more TDLS discovery response frames from one or more TDLS responders.

FIG. 5 is a flowchart illustrating a TDLS setup process according to an embodiment. The communication method shown in FIG. 5 may be applied to a TDLS initiator, such as a non-AP MLD.

Referring to FIG. 5, in operation 510, the TDLS initiator may determine a TDLS setup request frame. Specifically, the TDLS initiator may determine one or more BSSIDs carried in the TDLS setup request frame.

For example, the TDLS initiator may determine a station device with a TDLS function based on the received TDLS discovery response frame (operation 220 in FIG. 2), determine an identifier (BSSID) of a BSS to which a station device with which the TDLS initiator intends to set up a TDLS connection belongs, and carry the BSSID in the TDLS setup request frame. If the TDLS initiator discovers a plurality of TDLS responders and intends to set up a plurality of TDLS connections with at least two of the TDLS responders, the TDLS setup request frame sent by the TDLS initiator may carry a plurality of BSSIDs. If the TDLS initiator intends to set up a TDLS connection with only one TDLS responder (an ordinary STA or a non-multi-link station device), the TDLS setup request frame may include only one BSSID. The TDLS setup request frame may carry one or more BSSIDs in various forms, which is not specifically limited in the present disclosure.

In operation 520, the TDLS initiator may send the determined TDLS setup request frame.

FIG. 6 is a flowchart illustrating a TDLS setup process according to an embodiment. The communication method shown in FIG. 6 may be applied to a TDLS initiator, such as a non-AP MLD.

Referring to FIG. 6, in operation 610, the TDLS initiator may send a TDLS setup request frame. For example, the TDLS setup request frame may include one or more BSSIDs. Each BSSID indicates an identifier of a BSS to which a station device discovered by the TDLS initiator belongs, where the station device is a station device with which the TDLS initiator intends to set up a TDLS connection.

For example, the TDLS initiator may determine, based on the received TDLS discovery response frame, a station device with which the TDLS initiator can set up a TDLS connection, and determine an identifier (BSSID) of a BSS to which the station device with which the TDLS initiator intends to set up a TDLS connection belongs, and carry the BSSID in the TDLS setup request frame and send the TDLS setup request frame. If the TDLS initiator discovers a plurality of TDLS responders and intends to set up a plurality of TDLS connections with more than one TDLS responder, the TDLS setup request frame sent by the TDLS initiator may carry a plurality of BSSIDs. The TDLS setup request frame may carry one or more BSSIDs in various forms, which is not specifically limited in the present disclosure.

In operation 620, the TDLS initiator may receive a TDLS setup response frame. For example, the TDLS setup response frame may include one or more status identifiers. Each status identifier may indicate a status of a TDLS connection setup request corresponding to a respective BSSID. For example, the status may indicate whether the TDLS connection requested by the TDLS initiator is accepted or rejected.

According to an embodiment of the present disclosure, the TDLS setup response frame may have different contents based on the BSSID included in the TDLS setup request frame.

In an embodiment of the present disclosure, if the TDLS setup request frame includes a BSSID, the TDLS setup response frame may include a status identifier, where the status identifier is set to accept the TDLS connection setup request or reject the TDLS connection setup request. As a non-limiting embodiment, the status identifier may be a status code, and a TDLS setup response frame action field may be as shown in Table 7 below.

TABLE 7
TDLS Setup Response frame Action field

| Order | Information |
|---|---|
| 1 | Category |
| 2 | TDLS Action |
| 3 | Status Code |
| 4 | Dialog Token |
| . . . | . . . |
| 18 | Link Identifier |
| 19 | Multi-Link |
| . . . | . . . |

It should be understood that the information in the TDLS setup request frame shown in Table 7, as well as the order of the information, is not limited to this. The contents in Table 7 may be varied according to different embodiments.

In another embodiment of the present disclosure, if the TDLS setup request frame includes a plurality of BSSIDs, the TDLS setup response frame may include a TDLS status list. The TDLS status list may include status identifiers corresponding to the plurality of BSSIDs in the TDLS setup request frame respectively. For example, each status identifier may be set to indicate that a TDLS connection setup request corresponding to the respective BSSID is accepted, or indicate that a TDLS connection setup request corresponding to the respective BSSID is rejected. As a non-limiting embodiment, each status identifier may be a status code.

As a non-limiting embodiment, a TDLS setup response frame action field may be as shown in Table 8 below.

TABLE 8
TDLS Setup Response frame Action field

| Order | Information |
|---|---|
| 1 | Category |
| 2 | TDLS Action |
| 3 | TDLS Status List |
| 4 | Dialog Token |
| . . . | . . . |
| 18 | Link Identifier |
| 19 | Multi-Link |
| . . . | . . . |

It should be understood that the information in the TDLS setup request frame shown in Table 8, as well as the order of the information, is not limited to this. The contents in Table 8 may be varied according to different embodiments.

According to an embodiment of the present disclosure, the TDLS status list may include one or more TDLS status information subfields, as shown in Table 9 below.

TABLE 9
TDLS Status Information

| | BSSID | Status Code |
|---|---|---|
| Octets: | 6 | 2 |

Referring to Table 9, each status information subfield includes a BSSID and a status code. The status code may indicate acceptance or rejection of a TDLS connection setup request corresponding to a respective BSSID. Although Table 9 shows the size (number of bits) of each subfield, this is merely exemplary and not limitations to the present disclosure.

According to an embodiment of the present disclosure, if the TDLS responder is a non-AP MLD and the TDLS setup request frame sent by the TDLS initiator includes a multi-link TDLS request, that is, the TDLS setup request frame carries a plurality of different BSSIDs and each BSSID may identify a BSS to which an affiliated STA of the TDLS responder belongs, then the TDLS responder may carry a plurality of status identifiers in the form shown in Tables 8 and 9. That is, The TDLS setup response frame may include a plurality of TDLS status information subfields. Each TDLS status information subfield may include a BSSID corresponding to the BSSID in the TDLS setup request frame, and a status code of that BSSID. For example, the TDLS responder may determine whether the affiliated STA corresponding to the BSSID in the TDLS setup request frame agrees to the corresponding TDLS connection setup request identified by the BSSID identifier, and indicate this in the status code.

Furthermore, although Tables 7 to 9 separately show the embodiments where the TDLS setup request frame includes one BSSID and the embodiments where the TDLS setup request frame includes a plurality of BSSIDs, the present disclosure is not limited to this. For example, when the TDLS setup request frame includes only one BSSID, the TDLS setup response frame may also carry the status identifier in the format shown in Tables 8 and 9. In this case, for example, the TDLS setup response frame may include only one TDLS status information subfield.

If, in operation 620, one or more status identifiers in the TDLS setup response frame indicate acceptance of the TDLS connection setup request corresponding to the BSSID identifier, the TDLS initiator and TDLS responder may directly perform data transmission through the TDLS connection as set up.

According to the communication method of the embodiment of the present disclosure, when the TDLS initiator is a non-AP MLD, carrying one or more BSSIDs in the TDLS setup request frame and carrying one or more status identifiers in the TDLS setup response frame can avoid the problems of high signaling overhead and long TDLS connection setup time caused by the discovery and setup processes that need to be performed under each connection when the multi-link TDLS is set up, which further improves transmission efficiency.

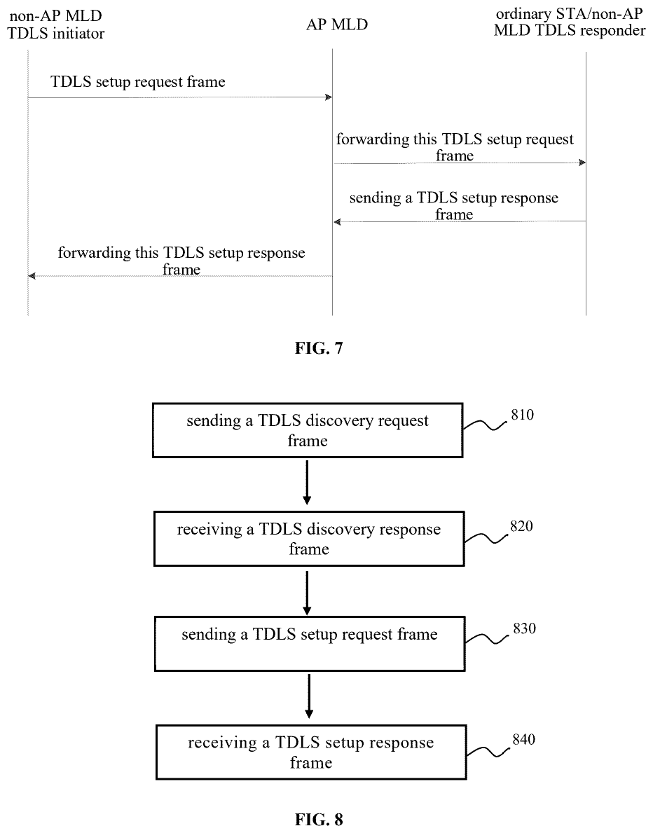

FIG. 7 is an interaction flowchart illustrating a TDLS setup process according to an embodiment.

Referring to FIG. 7, the TDLS initiator (non-AP MLD) may send a TDLS setup request frame to an AP MLD, where the AP MLD is associated with the TDLS initiator and has set up a multilink with the TDLS initiator. As described above with reference to FIGS. 5 and 6 and Tables 7 to 9, the TDLS setup request frame may include one or more BSSIDs. Each BSSID indicates an identifier of a BSS to which a station device discovered by the TDLS initiator and with which the TDLS initiator intends to set up a TDLS connection belongs.

Upon receiving the TDLS setup request frame sent by the TDLS initiator (non-AP MLD), the AP MLD may forward this TDLS setup request frame to the corresponding station device. That is, the TDLS setup request frame sent by the TDLS initiator is forwarded to the corresponding station device via a multi-link access point device.

The TDLS responder may determine whether to accept the TDLS setup request upon receiving the TDLS setup request frame sent by the AP MLD associated with the TDLS responder, and based on the determination result, determine and send the TDLS response frame.

In an embodiment of the present disclosure, if the TDLS responder is a non-multi-link station device (ordinary STA) or the TDLS setup request frame includes only a single-link TDLS request (i.e., the TDLS setup request frame carries only one BSSID), the TDLS setup response frame sent by the TDLS responder carries one status identifier (e.g., carrying the status code field but not the TDLS status list field), where the status code field is used for indicating whether the TDLS responder accepts the TDLS setup request. This may be analogous to the embodiment described with reference to Table 7 above. For brevity, redundant descriptions are omitted herein.

In another embodiment of the present disclosure, if the TDLS responder is a non-AP MLD and the TDLS setup request frame includes a multi-link TDLS request (i.e., the TDLS setup request frame carries a plurality of different BSSIDs, and each BSSID may identify a BSS to which an affiliated STA of the TDLS responder belongs), the TDLS setup response frame sent by the TDLS responder may carry a plurality status identifiers (e.g., carrying the TDLS status list field but not the status code field). The TDLS status list field includes a plurality of TDLS status information subfields, where the status code in a single TDLS status information indicates whether the TDLS responder accepts the TDLS setup request identified by the BSSID in the TDLS status information. This may be analogous to the embodiments described above with reference to Tables 8 and 9. For brevity, redundant descriptions are omitted.

Continuing with reference to FIG. 7, the TDLS initiator may receive the TDLS setup response frame from the TDLS responder via the AP MLD. However, although FIG. 7 shows that the TDLS initiator receives the TDLS setup response frame from only one TDLS responder, the present disclosure is not limited to this. The TDLS initiator may receive one or more TDLS setup response frames from one or more TDLS responders.

FIG. 8 illustrates a communication method for TDLS according to an embodiment of the present disclosure. The communication method shown in FIG. 8 may be applied to a TDLS initiator (e.g., a non-AP MLD).

Referring to FIG. 8, in operation 810, the TDLS initiator may send a TDLS discovery request frame. For example, the TDLS discovery request frame may include one or more BSSIDs, where each BSSID indicates an identifier of a BSS to which a station device with which the TDLS initiator intends to set up a TDLS connection belongs. Operation 810 may be analogous to operation 120 in FIG. 1, operation 210 in FIG. 2, and the operations in FIGS. 3 and 4 where the TDLS initiator sends the TDLS discovery request frame. For brevity, redundant descriptions are omitted herein.

In operation 820, the TDLS initiator may receive a TDLS discovery response frame to discover a station device with a TDLS function. Operation 820 may be analogous to operation 220 in FIG. 2, and the operations in FIGS. 3 and 4 where the TDLS initiator receives the TDLS discovery response frame. For brevity, redundant descriptions are omitted herein.

In operation 830, the TDLS initiator may send a TDLS setup request frame. For example, the TDLS setup request frame may include one or more BSSIDs, where each BSSID indicates an identifier of a BSS to which a station device discovered by the TDLS initiator and with which the TDLS initiator intends to set up a TDLS connection belongs. Operation 830 may be analogous to operation 520 in FIG. 5, operation 610 in FIG. 6, and the operation in FIG. 7 where the TDLS initiator sends the TDLS setup request frame. For brevity, redundant descriptions are omitted herein.

In operation 840, the TDLS initiator may receive a TDLS setup response frame. For example, the TDLS setup response frame may include one or more status identifiers, where each status identifier indicates a status of a TDLS connection setup request corresponding to a respective BSSID. Operation 840 may be analogous to operation 620 in FIG. 6, and the operation in FIG. 7 where the TDLS initiator receives the TDLS setup response frame. For brevity, redundant descriptions are omitted herein.

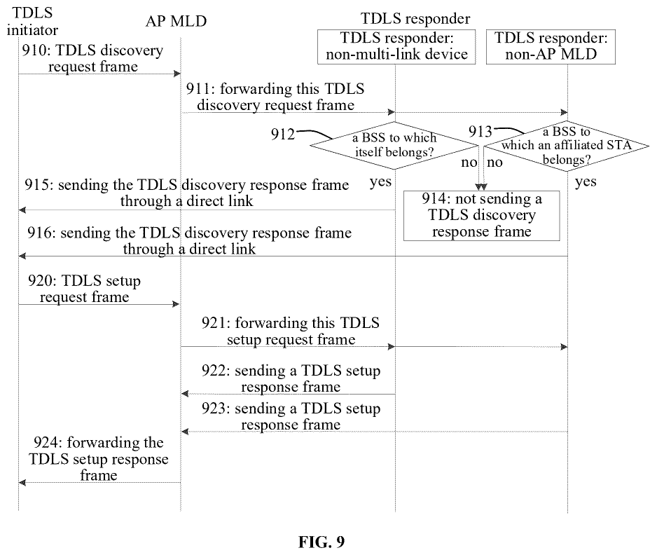

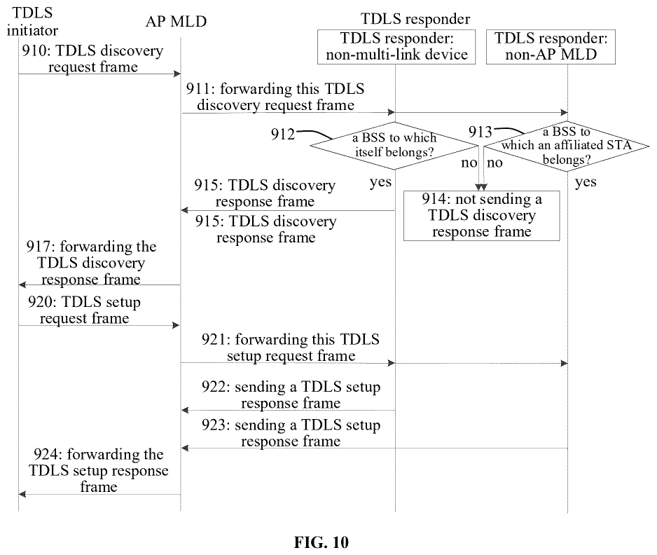

FIGS. 9 and 10 illustrate interaction flowcharts for TDLS according to an embodiment of the present disclosure.

Referring to FIG. 9, the TDLS initiator may send a TDLS discovery request frame to an AP MLD associated with the TDLS initiator (operation 910). The AP MLD may forward this TDLS discovery request frame to the TDLS responder (non-multi-link device or non-AP MLD) (operation 911). The TDLS discovery request frame in operations 910 and 911 may be analogous to the embodiments described with reference to FIGS. 1 to 4 above. For brevity, redundant descriptions are omitted herein.

Upon receiving the TDLS discovery request frame sent by the AP MLD associated with the TDLS responder, the TDLS responder may determine whether to reply with a TDLS discovery response frame based on the received TDLS discovery request frame.

When the TDLS responder is a non-multi-link station device, if at least one BSSID included in the TDLS discovery request frame received by the TDLS responder includes the identifier of the BSS to which the TDLS responder belongs (“yes” in operation 912), the TDLS responder sends the TDLS discovery response frame to the TDLS initiator through a direct link (operation 915); otherwise, the TDLS responder does not send the TDLS discovery response frame (operation 914).

When the TDLS responder is a non-AP MLD, if at least one BSSID included in the TDLS discovery request frame received by the TDLS responder includes an identifier of a BSS to which an affiliated STA of the TDLS responder belongs (“yes” in operation 913), the affiliated STA of the TDLS responder corresponding to that BSSID may send the TDLS discovery response frame to the TDLS initiator through a direct link (operation 916); otherwise, the TDLS responder does not send the TDLS discovery response frame (operation 914).

In operation 920, the TDLS initiator sends a TDLS setup request frame to the AP MLD associated with the TDLS initiator. In operation 921, the AP MLD forwards this TDLS setup request frame to the TDLS responder. The TDLS setup request frame in operations 920 and 921 may be analogous to the embodiments described with reference to FIGS. 5 to 7 above. For brevity, redundant descriptions are omitted herein.

Upon receiving the TDLS setup request frame sent by the TDLS initiator, the TDLS responder determines whether to accept the TDLS setup request. The determination result may be carried in the TDLS setup response frame, and is then sent to the associated AP MLD (operations 922 and 923). The AP MLD may forward the TDLS setup response frame to the TDLS initiator (operation 924).

When the TDLS responder is a non-multi-link station device (ordinary STA), the TDLS setup response frame sent by the TDLS responder carries one status identifier (e.g., carrying the status code field but not the TDLS status list field), where the status code field is used for indicating whether the TDLS responder accepts the TDLS setup request. This may be analogous to the embodiment described with reference to Table 7 above. For brevity, redundant descriptions are omitted herein. If the status identifier in the TDLS setup response frame sent in operation 922 indicates acceptance of the TDLS connection setup request corresponding to the BSSID identifier, the TDLS initiator and the TDLS responder may perform data transmission directly through the TDLS connection as set up in the subsequent communication.

When the TDLS responder is a non-AP MLD and the TDLS setup request frame includes a multi-link TDLS request (i.e., the TDLS setup request frame carries a plurality of different BSSIDs, and each BSSID may identify a BSS to which an affiliated STA of the TDLS responder belongs), the TDLS setup response frame sent by the TDLS responder may carry a plurality of status identifiers (e.g., carrying the TDLS status list field but not the status code field). The TDLS status list field includes a plurality of TDLS status information subfields, where the status code in a single TDLS status information indicates whether the TDLS responder accepts the TDLS setup request identified by the BSSID in the TDLS status information. This may be analogous to the embodiments described with reference to Tables 8 and 9 above. For brevity, redundant descriptions are omitted herein. If a plurality of status identifiers or a portion thereof in the TDLS setup response frame sent in operation 923 indicate acceptance of the TDLS connection setup request corresponding to the BSSID identifier, the TDLS initiator and the corresponding affiliated STA of the TDLS responder may perform data transmission directly through the TDLS connection as set up in the subsequent communication.

FIG. 10 illustrates an interaction flowchart for TDLS according to an embodiment of the present disclosure. In FIG. 10, except that the TDLS discovery response frame is forwarded to the TDLS initiator via a multi-link access point device (operations 915 to 917), the other processes are the same as those in FIG. 9. For brevity, redundant descriptions are omitted herein.

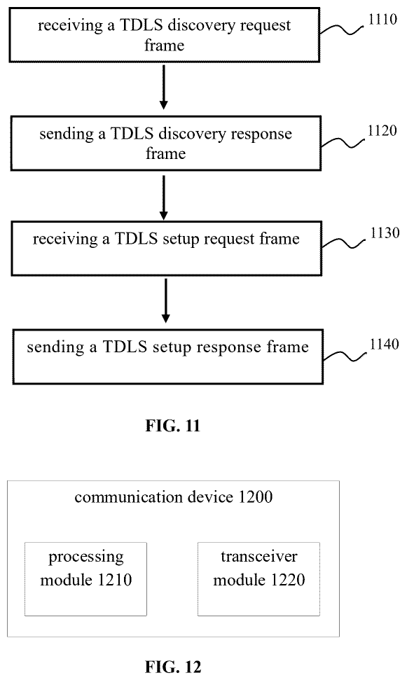

FIG. 11 illustrates a communication method for TDLS according to an embodiment of the present disclosure. The communication method shown in FIG. 11 may be applied to a TDLS responder (e.g., an ordinary STA or a non-AP MLD).

Referring to FIG. 11, in operation 1110, the TDLS responder may receive a TDLS discovery request frame. For example, the TDLS discovery request frame may include one or more BSSIDs, where each BSSID may indicate an identifier of a BSS to which a station device with which the TDLS initiator intends to set up a TDLS connection belongs. The TDLS discovery request frame in operation 1110 may correspond to the embodiments of the TDLS discovery request frame described above with reference to FIGS. 1 to 4. For brevity, redundant descriptions are omitted herein.

In operation 1120, when a BSSID in the TDLS discovery request frame corresponds to a BSSID to which the TDLS responder belongs, the TDLS responder may send a TDLS discovery response frame. The TDLS discovery response frame in operation 1120 may correspond to the embodiments of the TDLS discovery response frame described above with reference to FIGS. 2 to 4. For brevity, redundant descriptions are omitted herein.

In operation 1130, the TDLS responder may receive a TDLS setup request frame. For example, the TDLS setup request frame may include one or more BSSIDs, where each BSSID may indicate an identifier of a BSS to which a station device discovered by the TDLS initiator and with which the TDLS initiator intends to set up the TDLS connection belongs. The TDLS setup request frame in operation 1130 may correspond to the embodiments of the TDLS setup request frame described with reference to FIGS. 5 to 7 above. For brevity, redundant descriptions are omitted herein.

In operation 1140, if a BSSID in the TDLS setup request frame corresponds to the BSSID to which the TDLS responder belongs, the TDLS responder may send a TDLS setup response frame. For example, the TDLS setup response frame may include one or more status identifiers, where each status identifier may indicate a status of a TDLS connection setup request corresponding to a respective BSSID. The TDLS setup response frame in operation 1140 may correspond to the embodiments of the TDLS setup response frame described above with reference to FIGS. 6 and 7. For brevity, redundant descriptions are omitted herein.

FIG. 12 is a block diagram illustrating a communication device according to an embodiment of the present disclosure.

Referring to FIG. 12, the communication device 1200 may include a processing module 1210 and a transceiver module 1220. The communication device shown in FIG. 12 may be applied to a TDLS initiator or a TDLS responder.

When the communication device shown in FIG. 12 is applied to the TDLS initiator, the transceiver module 1220 may be configured to: send a TDLS discovery request frame, where the TDLS discovery request frame includes one or more BSSIDs, each BSSID indicates an identifier of a BSS to which a station device with which the TDLS initiator intends to set up a TDLS connection belongs; receive a TDLS discovery response frame to discover a station device with a TDLS function; send a TDLS setup request frame, where the TDLS setup request frame includes one or more BSSIDs, each BSSID indicates an identifier of a BSS to which a station device discovered by the TDLS initiator and with which the TDLS initiator intends to set up the TDLS connection belongs; and receive a TDLS setup response frame, where the TDLS setup response frame includes one or more status identifiers, and each status identifier indicates a status of a TDLS connection setup request corresponding to a respective BSSID. The processing module 1210 may be configured to control the operation of the transceiver module 1220, or determine the TDLS discovery request frame, determine the station device with the TDLS function based on the TDLS discovery response frame, and initiate the TDLS setup request with the desired station device.

In the case where the communication device shown in FIG. 12 is applied to the TDLS initiator, the communication device 1200 may perform the communication method described with reference to FIGS. 1, 2, 5, 6, and 8, and the operations performed by the TDLS initiator in FIGS. 3, 4, 7, 9, and 10. For brevity, redundant descriptions are omitted herein.

In the case where the communication device shown in FIG. 12 is applied to the TDLS responder, the transceiver module 1220 may be configured to: send a TDLS discovery request frame, where the TDLS discovery request frame includes one or more BSSIDs, each BSSID indicates an identifier of a BSS to which a station device with which the TDLS initiator intends to set up a TDLS connection belongs; receive a TDLS discovery response frame to discover a station device with a TDLS function; send a TDLS setup request frame, where the TDLS setup request frame includes one or more BSSIDs, each BSSID indicates an identifier of a BSS to which a station device discovered by the TDLS initiator and with which the TDLS initiator intends to set up the TDLS connection belongs; and receive a TDLS setup response frame, where the TDLS setup response frame includes one or more status identifiers, and each status identifier indicates a status of a TDLS connection setup request corresponding to a respective BSSID. The processing module 1210 may be configured to control the operation of the transceiver module 1220, or determine whether to send a TDLS discovery response frame based on the received TDLS discovery request frame, or determine whether to accept a TDLS connection setup request (i.e., determine the status of one or more status identifiers) based on the received TDLS setup response frame.

When the communication device shown in FIG. 12 is applied to the TDLS responder, the communication device 1200 may perform the communication method described with reference to FIG. 11, and the operations performed by the TDLS responder in FIGS. 3, 4, 7, 9, and 10. For brevity, redundant descriptions are omitted herein.

Furthermore, the communication device 1200 shown in FIG. 12 is merely exemplary, and the embodiments of the present disclosure are not limited to this. For example, the communication device 1200 may further include other modules, such as a memory module, etc. Additionally, the modules in the communication device 1200 may be combined into more complex modules or may be divided into more separate modules.

The communication method and the communication device according to the embodiments of the present disclosure improve the TDLS mechanism, enabling further improvement in transmission efficiency.

Based on the same principles as the method provided by the embodiments of the present disclosure, the embodiments of the present disclosure also provide an electronic device. The electronic device includes a processor and a memory, where the memory stores a machine-readable instruction (also referred to as a “computer program”). The processor is configured to execute the machine-readable instruction to implement the method described with reference to FIGS. 1 to 11.

The embodiments of the present disclosure also provide a computer-readable storage medium. The computer-readable storage medium stores a computer program. The computer program, when executed by a processor, implements the method described with reference to FIGS. 1 to 11.

In an embodiment, the processor may be configured to implement or execute various exemplary logical blocks, modules, and circuits described in connection with the contents of the present disclosure, for example, the processor may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. The processor may also be a combination implementing computational functions, such as a combination of one or more microprocessors, a combination of a DSP and a microprocessor, etc.

In an embodiment, the memory may be, for example, a read-only memory (ROM), a random access memory (RAM), an electrically erasable programmable read-only memory (EEPROM), a compact disc read only memory (CD-ROM), or other optical disc storage, disc storage (including compressed optical discs, laser discs, optical discs, digital versatile discs, Blu-ray discs, etc.), a disk storage medium or other magnetic storage device, or any other medium capable of being used for carrying or storing a program code in the form of instructions or data structures and accessible by a computer, but not limited to these.

It should be understood that although the steps in the flowchart of the accompanying drawings are shown sequentially according to the indication of the arrows, these steps are not necessarily executed in the order indicated by the arrows. Unless explicitly stated in this article, there is no strict order limit for the execution of these steps, and they can be executed in other orders. In addition, at least some of the steps in the flowchart of the accompanying drawings may include a plurality of sub steps or a plurality of phrases, and these sub steps or phrases are not necessarily executed and completed at the same time point, but can be executed at different time points, and their execution order is not necessarily sequential, but can be performed in turn or alternately with other steps or at least some of the sub steps of other steps or phrases.

Although the present disclosure has been illustrated and described with reference to certain embodiments of the present disclosure, those skilled in the art will understand that various modifications may be made in form and detail without departing from the scope of the present disclosure. Therefore, the scope of the present disclosure should not be construed as limited to the embodiments, but rather should be defined by the appended claims and their equivalents.

1. A communication method for tunneled direct link setup (TDLS), performed by a TDLS initiator comprising:
sending a TDLS discovery request frame, wherein the TDLS discovery request frame comprises one or more basic service set identifiers (BSSIDs), and each BSSID indicates an identifier of a first basic service set (BSS), wherein the TDLS initiator intends to set up a TDLS connection with a first station device, and the first station device belongs to the first BSS;
receiving a TDLS discovery response frame to discover a second station device with a TDLS function;
sending a TDLS setup request frame, wherein the TDLS setup request frame comprises one or more BSSIDs, and each BSSID in the TDLS setup request frame indicates an identifier of a second BSS, wherein a third station device discovered by the TDLS initiator belongs to the second BBS and the TDLS initiator intends to set up the TDLS connection with the third station device; and
receiving a TDLS setup response frame, wherein the TDLS setup response frame comprises one or more status identifiers, and each status identifier indicates a status of a TDLS connection setup request corresponding to a respective BSSID.

2. The communication method according to claim 1, wherein the TDLS discovery request frame comprises a plurality of BSSIDs, and the TDLS discovery request frame comprises one or more link identifier elements.

3. The communication method according to claim 2, wherein the TDLS discovery request frame comprises a plurality of link identifier elements, and of the plurality of BSSIDs in the TDLS discovery request frame are carried in the plurality of link identifier elements in one-to-one correspondence; or
the TDLS discovery request frame comprises a link identifier element, and the plurality of BSSIDs in the TDLS discovery request frame are comprised in the link identifier element in a form of a list.

4. The communication method according to claim 2, wherein each link identifier element further comprises a TDLS initiator address and a TDLS responder address.

5. The communication method according to claim 1, wherein the TDLS setup request frame comprises a BSSID, the TDLS setup response frame comprises a status identifier, and the status identifier is set to accept the TDLS connection setup request or reject the TDLS connection setup request.

6. The communication method according to claim 1, wherein the TDLS setup request frame comprises a plurality of BSSIDs, the TDLS setup response frame comprises a TDLS status list, and the TDLS status list comprises status identifiers in one-to-one correspondence with the plurality of BSSIDs in the TDLS setup request frame.

7. The communication method according to claim 1, wherein the TDLS discovery request frame and the TDLS setup request frame are forwarded to a respective station device via a multi-link access point device.

8. The communication method according to claim 1, wherein the TDLS discovery response frame is received via a multi-link access point device or through a direct link; and the TDLS setup response frame is received via a multi-link access point device.

9. A communication method for tunneled direct link setup (TDLS), performed by a TDLS responder comprising:
receiving a TDLS discovery request frame, wherein the TDLS discovery request frame comprises one or more basic service set identifiers (BSSIDs), and each BSSID indicates an identifier of a first basic service set (BSS), wherein the TDLS initiator intends to set up a TDLS connection with a first station device, and the first station device belongs to the first BSS;
sending a TDLS discovery response frame in response to a BSSID in the TDLS discovery request frame corresponding to a BSSID, wherein the TDLS responder belongs to the BSSID;
receiving a TDLS setup request frame, wherein the TDLS setup request frame comprises one or more BSSIDs, and each BSSID in the TDLS setup request frame indicates an identifier of a second BSS, wherein a third station device discovered by the TDLS initiator belongs to the second BBS and the TDLS initiator intends to set up the TDLS connection with the third station device; and
sending a TDLS setup response frame in response to a BSSID in the TDLS setup request frame corresponding to the BSSID, wherein the TDLS responder belongs to the BSSID, and wherein the TDLS setup response frame comprises one or more status identifiers, and each status identifier indicates a status of a TDLS connection setup request corresponding to a respective BSSID.

10. The communication method according to claim 9, wherein the TDLS discovery request frame comprises a plurality of BSSIDs, and the TDLS discovery request frame comprises one or more link identifier elements.

11. The communication method according to claim 10, wherein the TDLS discovery request frame comprises a plurality of link identifier elements, and of the plurality of BSSIDs in the TDLS discovery request frame are carried in the plurality of link identifier elements in one-to-one correspondence; or
the TDLS discovery request frame comprises a link identifier element, and the plurality of BSSIDs in the TDLS discovery request frame are comprised in the link identifier element in a form of a list.

12. The communication method according to claim 10, wherein each link identifier element further comprises a TDLS initiator address and a TDLS responder address.

13. The communication method according to claim 9, wherein the TDLS setup request frame comprises a BSSID, the TDLS setup response frame comprises a status identifier, and the status identifier is set to accept the TDLS connection setup request or reject the TDLS connection setup request.

14. The communication method according to claim 9, wherein the TDLS setup request frame comprises a plurality of BSSIDs, the TDLS setup response frame comprises a TDLS status list, and the TDLS status list comprises status identifiers in one-to-one correspondence with the plurality of BSSIDs in the TDLS setup request frame respectively.

15. The communication method according to claim 9, wherein the TDLS discovery request frame and the TDLS setup request frame are sent from the TDLS initiator and is forwarded to the TDLS responder via a multi-link access point device.

16. The communication method according to claim 9, wherein the TDLS discovery response frame is forwarded to the TDLS initiator via a multi-link access point device, or is sent to the TDLS initiator through a direct link; and the TDLS setup response frame is forwarded to the TDLS initiator via a multi-link access point device.

17-18. (canceled)

19. An electronic device, comprising:
a processor; and
a memory, storing a computer program executable by the processor,
wherein the processor, through executing the computer program, is configured to:
send a TDLS discovery request frame, wherein the TDLS discovery request frame comprises one or more basic service set identifiers (BSSIDs), and each BSSID indicates an identifier of a first basic service set (BSS), wherein the TDLS initiator intends to set up a TDLS connection with a first station device, and the first station device belongs to the first BSS;
receive a TDLS discovery response frame to discover a second station device with a TDLS function;
send a TDLS setup request frame, wherein the TDLS setup request frame comprises one or more BSSIDs, and each BSSID in the TDLS setup request frame indicates an identifier of a second BSS, wherein a third station device discovered by the TDLS initiator belongs to the second BBS and the TDLS initiator intends to set up the TDLS connection with the third station device; and
receive a TDLS setup response frame, wherein the TDLS setup response frame comprises one or more status identifiers, and each status identifier indicates a status of a TDLS connection setup request corresponding to a respective BSSID.

20. A non-transitory computer-readable storage medium, storing a computer program that, when executed by a processor, causes the processor to perform the method according to claim 1.

21. An electronic device, comprising:
a processor; and
a memory, storing a computer program executable by the processor;
wherein the processor, through executing the program, is configured to perform the method according to claim 9.

22. A non-transitory computer-readable storage medium, storing a computer program that, when executed by a processor, causes the processor to perform the method according to claim 9.
